(19) United States
(12) Patent Application Publication
(10) Pub. No.: US 2009/0140847 A1
(43) Pub. Date: Jun. 4, 2009

(54) Turning indication system for two-wheeled vehicle

(76) Inventors: Te-Ching Yen, Tainan City (TW); Sung-Yun Yen, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,286

(22) Filed: Nov. 29, 2007

(51) Int. Cl. B60Q 1/34

(52) U.S. Cl. 340/432; 340/465

(57) ABSTRACT

A turning indication system for a two-wheeled vehicle includes a first unit connected to a two-wheeled vehicle and emits signals when the vehicle turns. The first unit includes a mode switch unit from which the rider can set different operation modes. A second unit is connected to a helmet and includes a first light unit, a second light unit and a power source which is electrically connected to the first and second light units. The second unit receives the signals from the first unit and activating the first light unit and/or the second light unit according to a command of the mode switch unit. The first light unit includes at least one light emitting diode and the second light unit displays in a form of a pattern or character. The system provides an obvious signal to the riders following.

### FIELD OF THE INVENTION

The present invention relates to a turning indication system for providing obvious signals when turning and the system includes a turning indication device on helmet.

### BACKGROUND OF THE INVENTION

Generally, when two motorcyclists riding two motorcycles on a road, the second motorcyclist usually pays attention at a height about the shoulder and head of the first motorcyclist so as to check the road conditions ahead. When the first motorcyclist operates turning lights which are located at lower position relative to the second motorcyclist, the second motorcyclist may not notice the turning signal immediately and this might lead to an accident.

Similarly, when two bicyclists riding two bicycles on a road, the second bicyclist usually pays attention at a height about the shoulder and head of the first bicyclist so as to check the road conditions ahead. The bicycles usually include a reflection member on its rear end and no other turning indication device is available. When the first bicyclist wants to turn and does not show a proper signal, the second bicyclist might not able to reduce speed and might hit the first bicycle.

The present invention intends to provide a turning indication system for motorcycles and bicycles and the system includes a turning indication device on a helmet so as to show an obvious signal to the following motorcyclist or bicyclist.

### SUMMARY OF THE INVENTION

The present invention relates to a turning indication system for a two-wheeled vehicle and includes a first unit connected to a two-wheeled vehicle and emits signals when the vehicle turns. The first unit includes a mode switch unit from which the rider can set different operation modes. A second unit is connected to a helmet and includes a first light unit, a second light unit and a power source which is electrically connected to the first and second light units. The first light unit and/or the second light unit are activated when the second unit receives the signals from the first unit. The first light unit includes at least one light emitting diode and the second light unit displays in a form of a pattern or character.

If the two-wheeled vehicle is a motorcycle, the first unit is electrically connected to turning lights of the motorcycle and includes a detection unit which is electrically connected to the turning lights, a signal emitting unit is electrically connected to the detection unit and emits signals to the second unit when the detection unit detects the turning lights are activated.

If the two-wheeled vehicle is a bicycle, the first unit includes a turning unit and a signal emitting unit which is electrically connected to the turning unit and the mode switch unit. The signal emitting unit emits signals to the second unit when the signal emitting unit receives signals from the turning unit. A power source is electrically connected with the mode switch unit, the turning unit and the signal emitting unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the turning indication system for a rider and a motorcycle;

FIG. 2 shows electrical diagram of the first and second units of the turning indication system of the present invention used for a motorcycle;

FIG. 3 shows the first unit installed to a motorcycle;

FIG. 4 shows the second unit connected to a motorcycle helmet;

FIG. 5 shows electrical diagram of the first and second units of the turning indication system of the present invention used for a bicycle;

FIG. 6 shows the first unit installed to a bicycle;

FIG. 7 shows the second unit connected to the bicycle helmet;

FIG. 8 shows the operation of the second light unit when the first mode is set, the second light unit shows a left turn signal in the form of an arrow;

FIG. 9 shows the operation of the second light unit when the first mode is set, the second light unit shows a right turn signal in the form of an arrow;

FIG. 10 shows the operation of the second light unit when the first mode is set, the second light unit shows a left turn signal in the form of the word “LEFT”;

FIG. 11 shows the operation of the second light unit when the first mode is set, the second light unit shows a right turn signal in the form of the word “RIGHT”;

FIG. 12 shows the operation of the first and second light units when the second mode is set, the second light unit shows a left turn signal in the form of an arrow;

FIG. 13 shows the operation of the first and second light units when the second mode is set, the second light unit shows a right turn signal in the form of an arrow;

FIG. 14 shows the operation of the first and second light units when the second mode is set, the second light unit shows a left turn signal in the form of the word “LEFT”, and

FIG. 15 shows the operation of the first and second light units when the second mode is set, the second light unit shows a right turn signal in the form of the word “RIGHT”.

### DETAILED DESCRIPTION OF THE PREFERRED EMBODIMENT

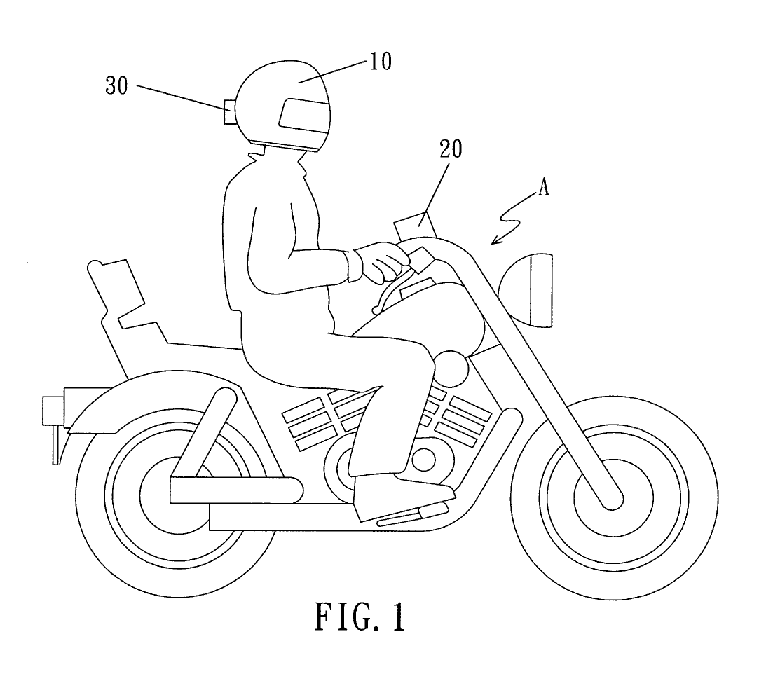

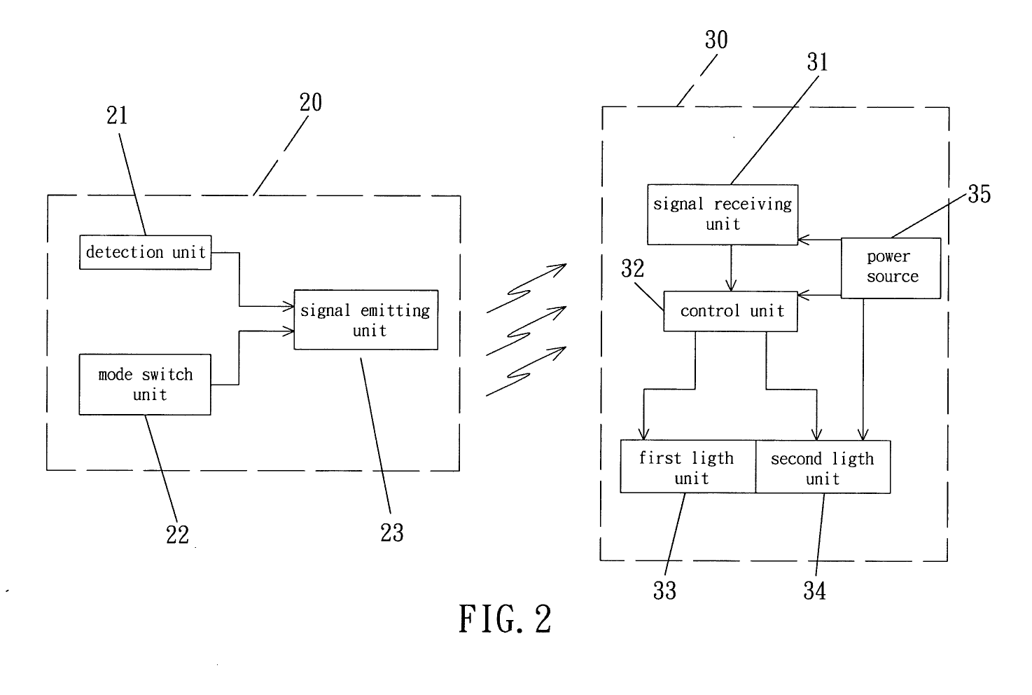

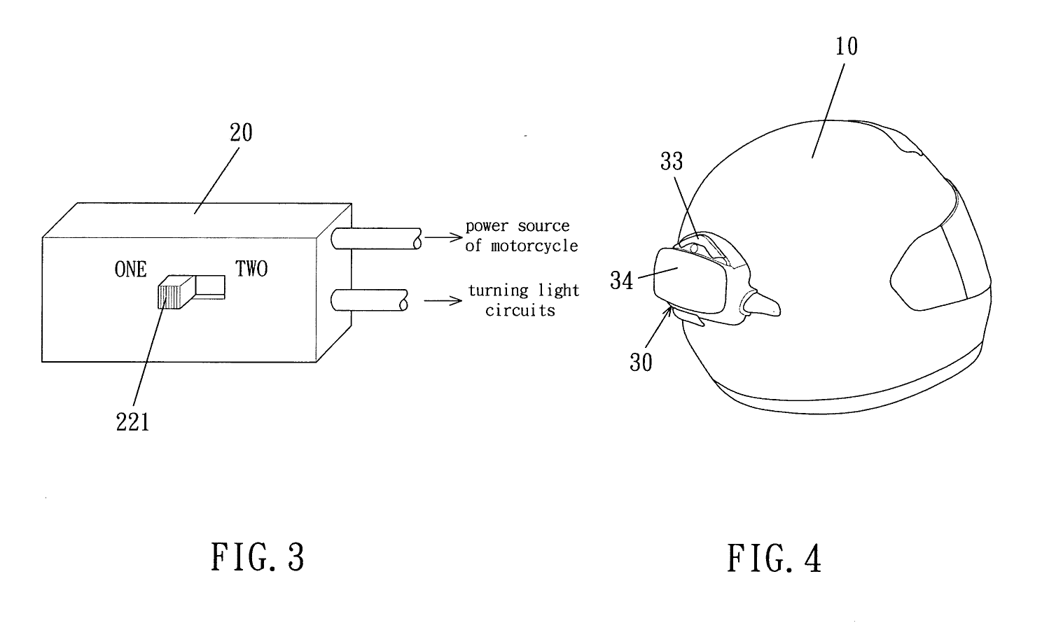

Referring to FIGS. 1 to 4, the first embodiment of the turning indication system of the present invention is used for a motorcycle “A” and the motorcycle helmet 10. A first unit 20 is connected to the motorcycle “A” and a second unit 30 is connected to a rear end of the helmet 10.

The first unit 20 is connected to the handlebar of the motorcycle “A” and electrically connected to turning lights of the motorcycle “A”, and is powered by the power source of the motorcycle “A”. The first unit 20 includes a detection unit 21 which is electrically connected to circuits of the turning lights, a mode switch unit 22 and a signal emitting unit 23 which is electrically connected to the mode switch unit 22 and the detection unit 21. A switch 221 is connected to the first unit 20 so that the rider can switch between first and second modes. When the rider operates the left turn light or right light of the motorcycle “A”, the detection unit 21 detects the signals of the turning lights and the signal emitting unit 23 emits signals to the second unit 30 according the commands to the mode switch unit 22.

The second unit 30 is fixed to a rear end of the motorcycle helmet 10 by glue or Velcro strips, and includes a signal receiving unit 31, a control unit 32, a first light unit 33, a second light unit 34 and a power source 35 which provides power to the signal receiving unit 31, the control unit 32, the first light unit 33 and the second light unit 34. The power source 35 can be any known batteries. The signal receiving unit 31 is electrically connected to the control unit 32 which is electrically connected with the first and second light unit 33 and 34. When the signal receiving unit 31 receives signals from the first unit 20, the control unit 32 activates the first and/or second light unit 33 and/or 34 according to the command of the mode switch unit 22. In this embodiment, the first light unit 33 includes five light emitting diodes which are high illumination light emitting diodes. The second light unit 34 is composed of multiple light emitting diodes which form a display area and display a pattern or character.

When the motorcycle “A” is activated, the first unit 20 is activated and sends radio signals to activate the second unit 30. The second unit 30 can also be activated manually. The rider operates the switch 221 to set the first and second light units 33, 34 to be operated by the first mode or the second mode. When the rider turns and operates the left turning light or the right turning light, the first unit 20 detects the left turning light or the right turning light is activated, the signal emitting unit 23 then sends signals to the second unit 30 to activate the first light unit 33 and/or the second light unit 34 according the mode set.

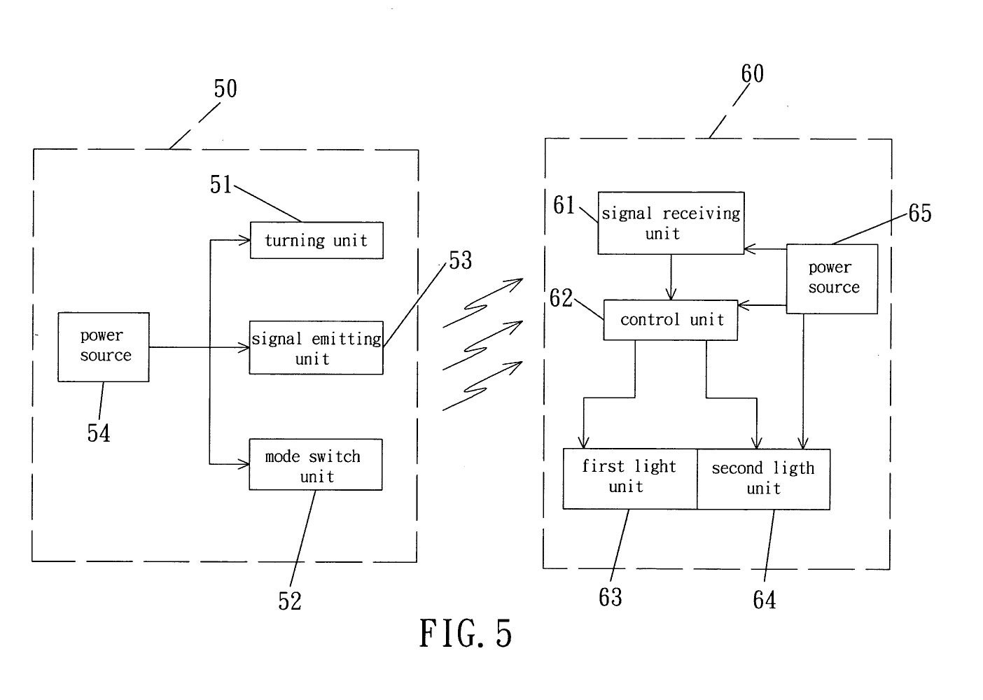

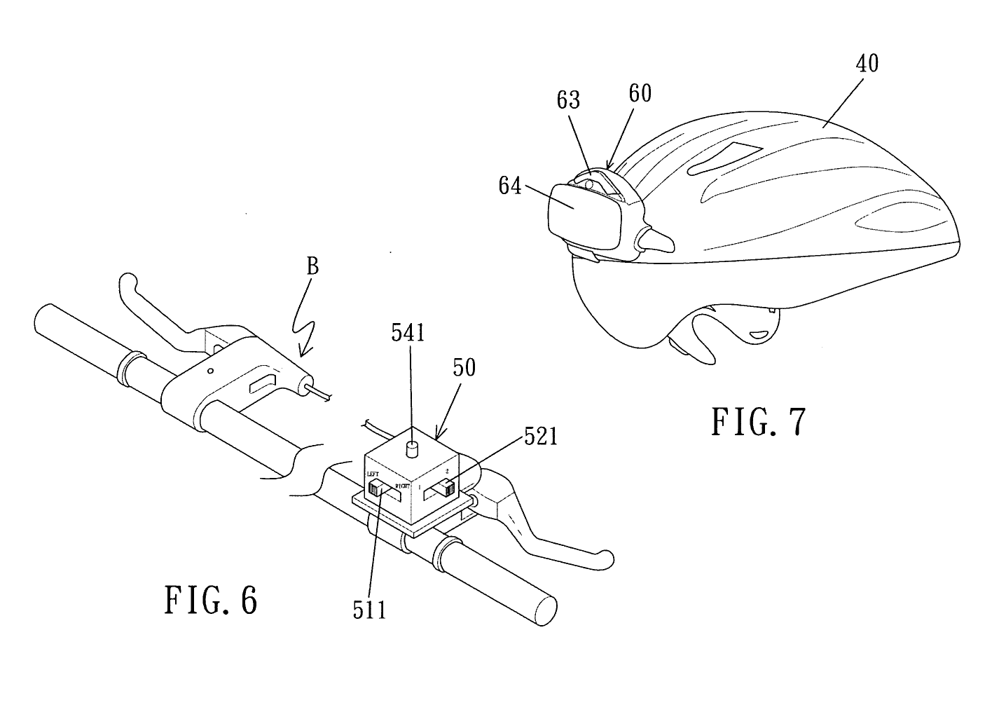

FIGS. 5 and 6 show a second embodiment of the present invention and the first unit 50 is connected to the handlebar “B” of the bicycle and the second unit 60 is connected to the bicycle helmet 40. The first unit 50 includes a turning unit 51, a mode switch unit 52, a signal emitting unit 53 which is electrically connected to the mode switch unit 52 and the turning unit 51, and a power source 54 which provides electric power to the turning unit 51, the mode switch unit 52 and the signal emitting unit 53. The first unit 50 includes an ON/OFF switch 541, a turning switch 511 and a mode switch 521 so that the rider can switch between first and second modes. When the rider operates the turning switch 511 to turn left or right, the signal emitting unit 53 emits signals to the second unit 60 according the commands to the mode switch unit 52. The power source 54 can be any known batteries.

The second unit 60 is fixed to a rear end of the bicycle helmet 40 by glue or Velcro strips, and includes a signal receiving unit 61, a control unit 62, a first light unit 63, a second light unit 64 and a power source 65 which provides power to the signal receiving unit 61, the control unit 62, the first light unit 63 and the second light unit 64. The power source 65 can be any known batteries. The signal receiving unit 61 is electrically connected to the control unit 62 which is electrically connected with the first and second light unit 63 and 64. When the signal receiving unit 61 receives signals from the first unit 50, the control unit 62 activates the first and/or second light unit 63 and/or 64 according to the command of the mode switch unit 52. In this embodiment, the first light unit 63 includes five light emitting diodes which are high illumination light emitting diodes. The second light unit 64 is composed of multiple light emitting diodes which form a display area and displays a pattern or character.

When the rider of the bicycle pushes the ON/OFF switch 541, the first unit 50 is activated and sends radio signals to activate the second unit 60. The second unit 60 can also be activated manually. The rider operates the mode switch 521 to set the first and second light units 63, 64 to be operated by the first mode or the second mode. When the rider turns and operates the turning switch 511, the signal emitting unit 53 then sends signals to the second unit 60 to activate the first light unit 63 and/or the second light unit 64 according the mode set.

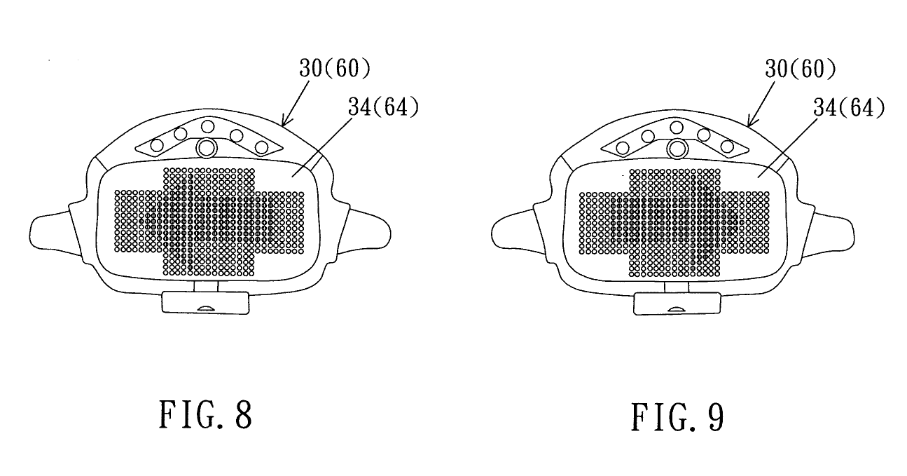

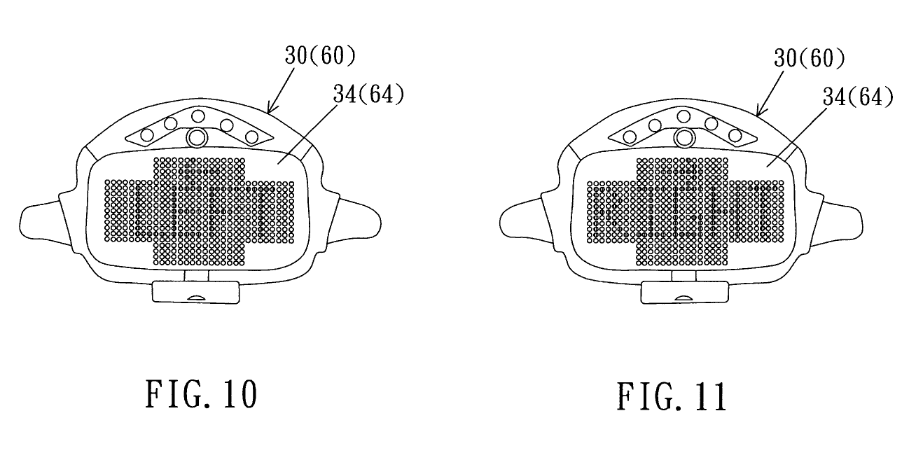

The first mode of the first and second light units 33/63, 34/64 of the turning indication system for both of the motorcycle and the bicycle are the same. The first mode is suitable for riding in day time, the second light unit 34/64 displays the left turning and right turning in the from of an arrow as shown in FIGS. 8 and 9, or in the form of the word “LEFT” and “RIGHT” as shown in FIGS. 10 and 11. The second light unit 34/64 can be constant light or flashing.

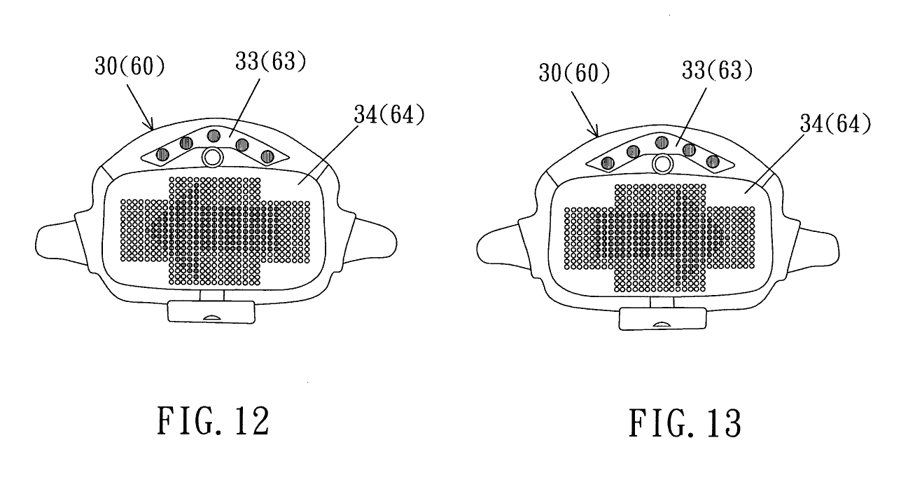

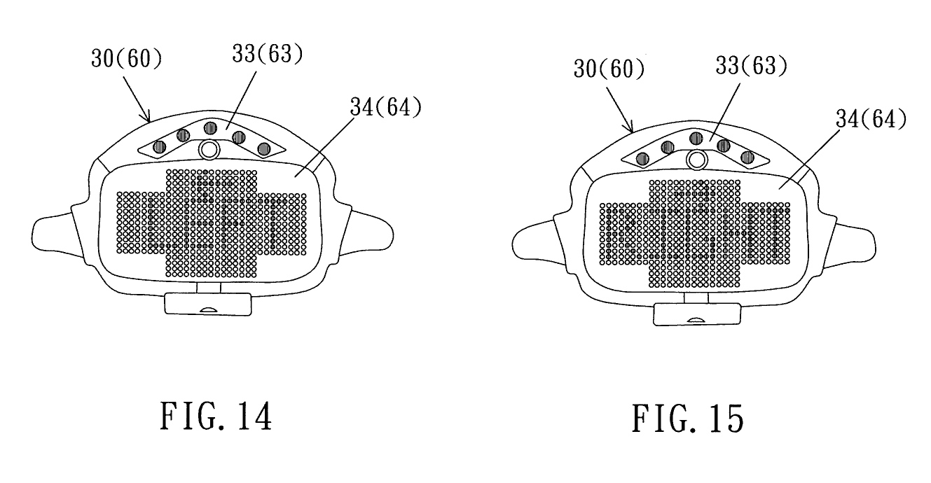

The second mode of the first and second light units 33/63, 34/64 of the turning indication system for both of the motorcycle and the bicycle are the same. The second mode is suitable for riding in night time, the first light unit 33/63 is flashing and the second light unit 34/64 displays the left turning and right turning in the from of an arrow as shown in FIGS. 12 and 13, or in the form of the word “LEFT” and “RIGHT” as shown in FIGS. 14 and 15. The second light unit 34/64 can also be flashing as the first light unit 33/63. The first and second light units 33/63 and 34/64 are in activated status and flash alternately.

The second unit 30/60 is connected to the rear end of the helmet 10/40 which is located at the view area of the riders of the following motorcycles and bicycles so that the obvious signals can be seen clearly and immediately.

The second light unit 34/64 includes a larger illumination area than the first light unit 33/63 and the arrows and/or words easily catch the riders' attention.

While we have shown and described the embodiment in accordance with the present invention, it should be clear to those skilled in the art that further embodiments may be made without departing from the scope of the present invention.

What is claimed is:

1. A turning indication system for a two-wheeled vehicle, comprising:
a first unit connected to a two-wheeled vehicle and including a mode switch unit, the first unit emitting signals when the vehicle turns, and
a second unit connected to a helmet and including a first light unit, a second light unit and a power source which is electrically connected to the first and second light units and, the second unit receiving the signals from the first unit and activating the first light unit and/or the second light unit according to a command of the mode switch unit, the first light unit including at least one light emitting diode and the second light unit displaying a pattern or character.

2. The system as claimed in claim 1, wherein the second unit includes a signal receiving unit, a control unit and the power source, the signal receiving unit is electrically connected to the control unit which is electrically connected with the first and second light unit and, when the signal receiving unit receives signals from the first unit, the control unit activates the first and/or second light unit according to the command of the mode switch unit, the power source is electrically connected to the signal receiving unit, the control unit and the mode switch unit.

3. The system as claimed in claim 1, wherein the two-wheeled vehicle is a motorcycle and the first unit is electrically connected to turning lights of the motorcycle, the first unit includes a detection unit which is electrically connected to the turning lights, a signal emitting unit is electrically connected to the detection unit and emits signals to the second unit when the detection unit detects the turning lights are activated.

4. The system as claimed in claim 1, wherein the two-wheeled vehicle is a bicycle and the first unit includes a turning unit and a signal emitting unit which is electrically connected to the turning unit and the mode switch unit, the signal emitting unit emits signals to the second unit when the signal emitting unit receives signals from the turning unit, a power source is electrically connected with the mode switch unit, the turning unit and the signal emitting unit.

5. The system as claimed in claim 1, wherein the mode switch unit includes a first operation mode and a second operation mode, the second light unit is activated when the first operation mode is set, the first and second light units are both activated when the second operation mode is set.

6. The system as claimed in claim 5, wherein the second light unit is flashing when the first operation mode is set.

7. The system as claimed in claim 5, wherein the first light unit is flashing when the second operation mode is set.

8. The system as claimed in claim 5, wherein the first and second light units are flashing synchronously when the second operation mode is set.

9. The system as claimed in claim 5, wherein the first and second light units are flashing alternately when the second operation mode is set.
